(19) United States
(12) Patent Application Publication
(10) Pub. No.: US 2016/0102457 A1
(43) Pub. Date: Apr. 14, 2016

(54) METHOD OF MAKING A RIGID FIBER GRID

(71) Applicant: Donald E. WHEATLEY, Dexter, MI (US)

(72) Inventor: Donald E. WHEATLEY, Dexter, MI (US)

(21) Appl. No.: 14/513,971

(22) Filed: Oct. 14, 2014

(51) Int. Cl. E04C 5/07; B32B 38/00; B32B 37/12; B32B 37/14; B32B 37/24

(52) U.S. Cl. CPC E04C 5/07; B32B 37/142; B32B 37/24; B32B 37/1284; B32B 38/1875; B32B 2037/243; B32B 2419/00

(57) ABSTRACT

A method of making a rigid fiber mesh grid includes forming a plurality of substantially rigidified elongated rods formed from fiber strands and forming a plurality of substantially round cross section wrapped fiber tows and tensioning the plurality of wrapped fiber tows in parallel to one another at predetermined laterally spaced intervals. The wrapped fiber tows are wetted with an adhesive. The plurality of substantially rigidified elongated rods are placed on top of and generally perpendicular to the plurality of wetted wrapped fiber tows at spaced intervals. The adhesive is then cured to secure the elongated rods to the plurality of wrapped fiber tows.

### FIELD

The present disclosure relates to reinforcement materials for concrete and other structures and more particularly to a method of making a rigid fiber grid.

### BACKGROUND

This section provides background information related to the present disclosure which is not necessarily prior art.

This disclosure relates to a product for use in reinforcing concrete walls and other concrete structures using rigid fiber grids. The rigid fiber grids can be embedded in a concrete structure.

### SUMMARY

This section provides a general summary of the disclosure, and is not a comprehensive disclosure of its full scope or all of its features.

A method of making a rigid fiber mesh grid includes forming a plurality of substantially rigidified elongated rods formed from fiber strands and forming a plurality of substantially round cross section wrapped fiber tows and tensioning the plurality of wrapped fiber tows longitudinally in parallel to one another at predetermined laterally spaced intervals. The wrapped fiber tows are wetted with an adhesive. The plurality of substantially rigidified elongated rods are placed on top of and generally perpendicular to the plurality of wetted wrapped fiber tows at spaced intervals. The adhesive is then cured to secure the elongated rods to the plurality of wrapped fiber tows.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top plan view of the formation of an exemplary fiber grid according to the principles of the present disclosure;

FIG. 2 is a schematic view of a process of making a rigid fiber grid according to the principles of the present disclosure;

FIG. 3 is a side plan view of an alternative process for making a rigid fiber grid according to the principles of the present disclosure; and

FIG. 4 is a schematic view of a further alternative process of making a rigid fiber grid according to the principles of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

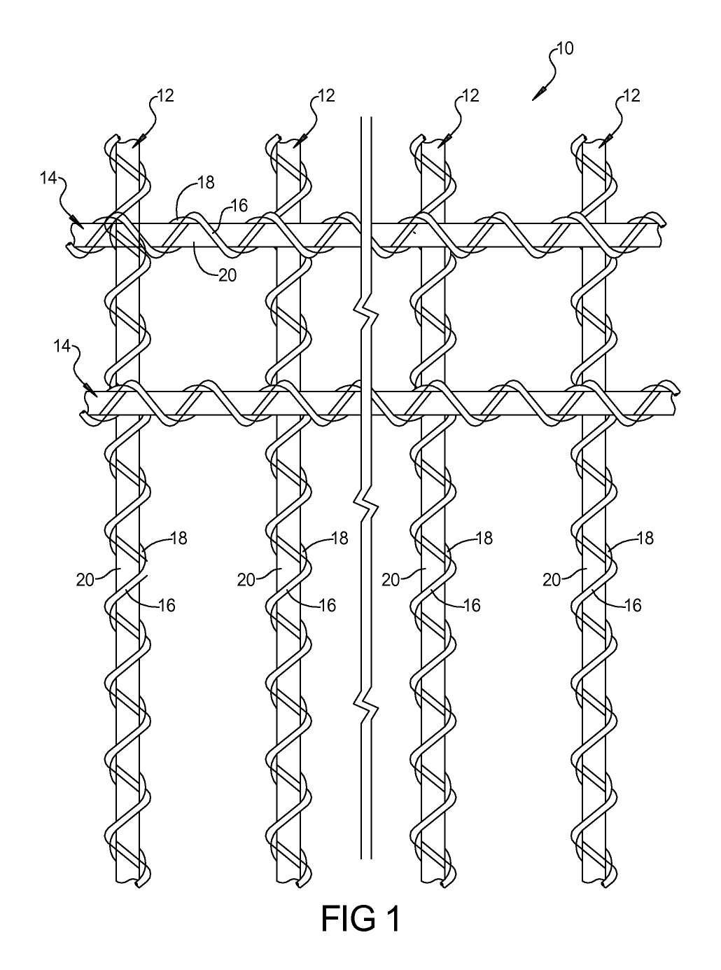

With reference to FIG. 1, a portion of a rigid fiber grid 10 is shown. The grid 10 comprises a plurality of longitudinal substantially round cross-section wrapped fiber tows 12 along with a plurality of substantially rigidified elongated rods 14 formed from fiber strands. The elongated rods 14 can be secured to the plurality of wrapped fiber tows 12 by an adhesive. The fiber strands that make up the wrapped fiber tows 12 and the elongated rods 14 can preferably include carbon fiber strands or alternatively can include Kevlar, nylon, poly-parapheneylene tetraphthalamide, para-aramid nylon, aramid fiber, aromatic polyamide, combinations thereof or other types of strands that are known to have strong tensile strength.

During a method of making the rigid fiber grid 10 the plurality of substantially rigidified elongated rods 14 are formed from individual fiber strands. As shown in FIG. 1, the substantially rigid elongated rods 14 each include individual fiber strands which are wrapped into a bundle by threads 16, 18 which are interwoven around each bundle 20. The wrapped bundle 20 takes on a generally round cross section of a rod. The elongated rods 14 are generally round in cross-section and made to be substantially rigid by coating the wrapped bundles 20 with an adhesive and allowing the adhesive to dry in a green state or can alternatively be fully cured by heating or introduction of ultraviolet light. By use of the term “substantially rigid” it is meant that the elongated rods 14 are capable of supporting themselves when held vertically upward or horizontally with little bending and without wilting under its own weight and yet may have some flexibility if forces are applied thereto. The elongated rods 14 are preferably cut to a desired length, of for example, 12 inches, 24 inches, 36 inches, and 48 inches.

As shown in FIG. 1, the longitudinal wrapped fiber tows 12 are continuous and are spaced at a predetermined laterally spaced intervals from one another. The wrapped fiber tows 12 each include fiber strands which are wrapped into a bundle by threads 16, 18 which are interwoven around each bundle 20.

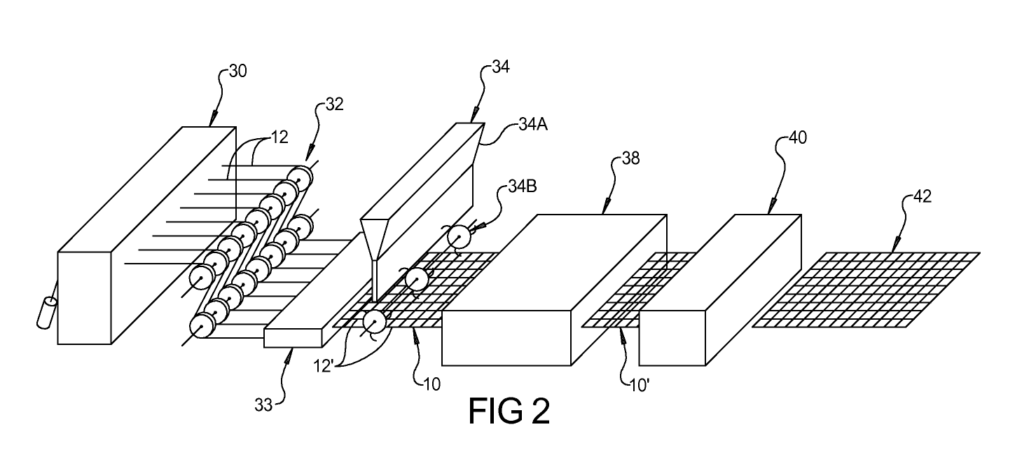

With reference to FIG. 2, the method of making the rigid fiber grid 10 according to the principles of the present disclosure will now be described. The plurality of longitudinal wrapped fiber tows 12 can be formed by a weaving machine 30 such as, for example, a Jacob Mueller Rashelina RD3 weaving machine that may be set up to automate the thread wrap pattern 16,18 of the fiber bundles 20 as shown in FIG. 1 or by using an alternative wrap pattern. The plurality of longitudinal wrapped fiber tows 12 can be fed directly from the weaving machine 30 or alternatively, can be fed from a plurality of spools (described in detail herein). The plurality of longitudinal wrapped fiber tows 12 can be fed around a series of laterally spaced pulleys 32 and fed through an adhesive wetting station 33 where the longitudinal wrapped fiber tows 12 are wetted with an adhesive such as an epoxy. Next, the wetted longitudinal wrapped fiber tows 12′ pass through a placement station 34 where the substantially rigidified elongated rods 14 are placed one at a time on the wetted longitudinal wrapped fiber tows 12′ at predetermined spaced longitudinal intervals so that the elongated rods 14 are generally perpendicular to the longitudinal wrapped fiber tows 12′ to thereby form a grid 10. The grid 10 is then passed through a curing station 38 in which the adhesive is cured. The curing station 38 can be a heated furnace or alternatively, can include an ultraviolet light for curing the adhesive. The cured grid 10′ is then pulled by a pulling and cutting station 40 which pulls the cured grid 10′ and can automatically cut the grids 10′ into rigid fiber grid sheets 42 having predetermined lengths, as desired. The pulling station 40 can frictionally engage the fiber tows 12 between two motor driven rollers to draw the fiber tows 12 through the system at a desired speed. Other alternative pulling devices can be used.

Placement station 34 can include a hopper 34A that automatically feeds the substantially rigidified elongated rods 14, one at a time, to a rotary placement device 34B that includes a motor drive that is timed and coordinated with the speed of the pulling station 40 in order to place the elongated rods 14 at the desired predetermined spaced intervals. The method of the present disclosure relies upon gravity along with the slow pulling movement of the longitudinal wrapped fiber tows 12 to maintain the elongated rods 14 in a stable position until the adhesive is cured.

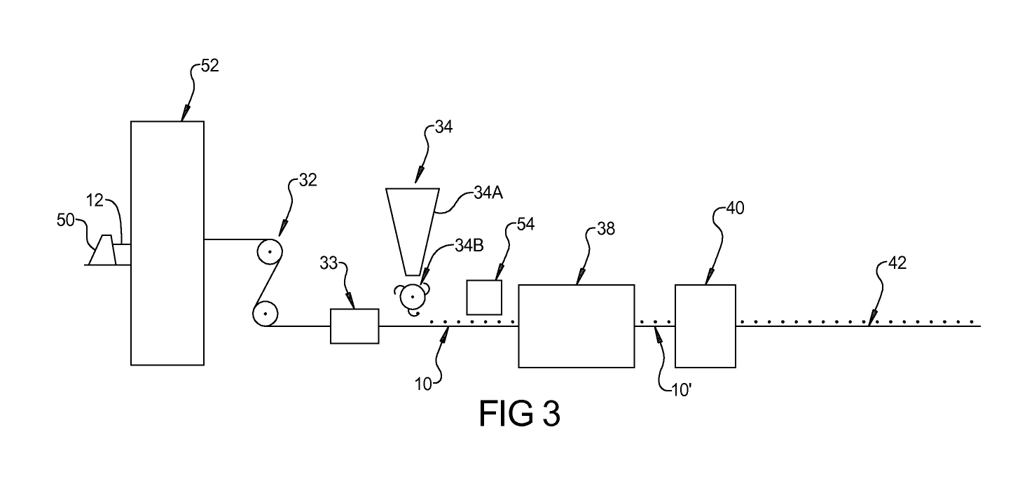

As an alternative, as shown in FIG. 3, the plurality of longitudinal wrapped fiber tows 12 can be fed from a plurality of pre-formed spools 50 (only one of which is shown) through a tensioning station 52. The tensioning station can include pulleys or sheaves that frictionally engage the fiber tows 12 to maintain a tension thereon between the tensioning station 52 and the pulling station 40. The plurality of longitudinal wrapped fiber tows 12 can be fed around a series of laterally spaced pulleys 32 and fed through an adhesive wetting station 33 where the longitudinal wrapped fiber tows 12 are wetted with an adhesive such as an epoxy. Next, the wetted longitudinal wrapped fiber tows 12′ pass through a placement station 34 where the substantially rigidified elongated rods 14 are placed one at a time on the wetted longitudinal wrapped fiber tows 12′ at predetermined spaced longitudinal intervals so that the elongated rods 14 are generally perpendicular to the longitudinal wrapped fiber tows 12′ to thereby form a grid 10. The grid 10 can optionally be passed through a coating station 54 in which the wetted plurality of wrapped fiber tows are coated with granular particles that can include particles of sand or quartz or other material. The grid 10 is then passed through a curing station 38 in which the adhesive is cured. The curing station 38 can be a heated furnace or alternatively, can include ultraviolet light(s) for curing the adhesive. The cured grid 10′ is then pulled by a pulling and cutting station 40 which pulls the cured grid 10′ and can optionally automatically cut the grids 10′ into rigid fiber grid sheets 42 having predetermined lengths, as desired.

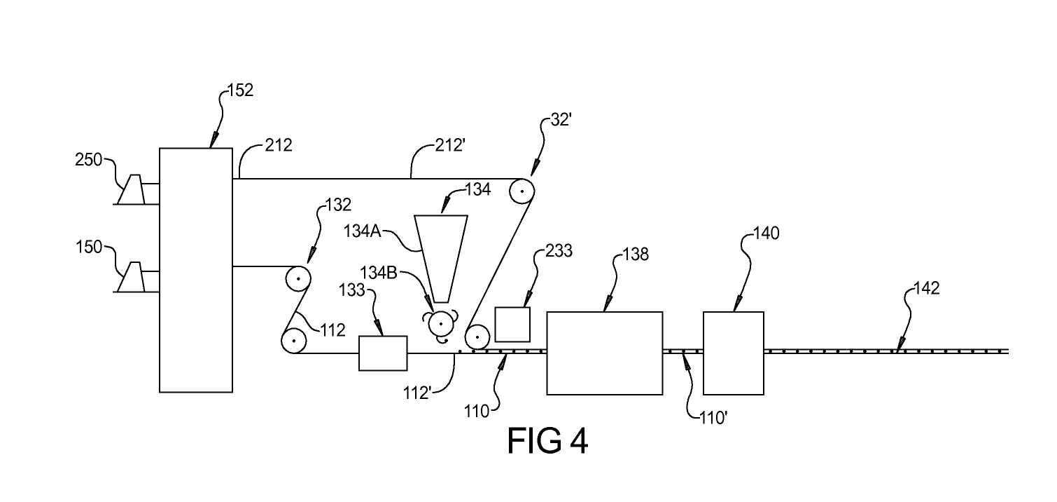

As an alternative, as shown in FIG. 4, a first plurality of longitudinal wrapped fiber tows 112 can be fed from a first plurality of spools 150 (only one of which is shown) through a tensioning station 152. The first plurality of longitudinal wrapped fiber tows 112 can be fed around a series of laterally spaced pulleys 132 and fed through an adhesive wetting station 133 where the first plurality of longitudinal wrapped fiber tows 112 are wetted with an adhesive such as an epoxy. Next, the wetted longitudinal wrapped fiber tows 112′ pass through a placement station 134 where the substantially rigidified elongated rods 14 are placed one at a time on the wetted longitudinal wrapped fiber tows 112′ at predetermined spaced longitudinal intervals so that the elongated rods 14 are generally perpendicular to the longitudinal wrapped fiber tows 112′. A second plurality of longitudinal wrapped fiber tows 212 can be fed from a second plurality of spools 250 (only one of which is shown) through the tensioning station 152. The second plurality of longitudinal wrapped fiber tows 212 can be fed around a series of laterally spaced pulleys 232 and fed through an additional adhesive wetting station 233 where at least the second plurality of longitudinal wrapped fiber tows 212 are wetted with an adhesive such as an epoxy. The second plurality of wetted longitudinal wrapped fiber tows 212′ are then introduced on top of the elongated rods 14 to thereby form a grid 110 having both upper and lower layers of longitudinal wrapped fiber tows 112′and 212′. The second plurality of wetted longitudinal wrapped fiber tows 212′ can be spaced between or alternatively directly above the first plurality of wetted longitudinal wrapped fiber tows 112′. The grid 110 can optionally be passed through a coating station (as shown in FIG. 3) in which the wetted plurality of wrapped fiber tows 112′, 212′ are coated with granular particles that can include, for example, particles of sand or quartz or other material. The grid 110 is then passed through a curing station 138 in which the adhesive is cured. The curing station 138 can be a heated furnace or alternatively, can include ultraviolet light(s) for curing the adhesive. The cured grid 110′ is then pulled by a pulling and cutting station 140 which pulls the cured grid 110′ and can optionally automatically cut the grids 110′ into rigid fiber grid sheets 142 having predetermined lengths, as desired.

The rigid fiber grids 10′, 110′ are especially well suited for use in reinforcing concrete structures and can be produced more quickly and with less expense than previous fiber grid designs. The round shape of the longitudinal fiber tows 12 and the transverse elongated rods 14 provide the grids 10′, 110′ with greater resistance to drooping in the vertical direction when the grids 10′, 110′ are placed horizontally in a space to be filled with concrete, so that the concrete can more readily flow around the grids 10′, 110′. The fiber grids 10′, 110′ are resistant to corrosion and are well suited for reinforcing concrete in salty environments such as, but not limited to, ocean side concrete roads and sidewalks and salt water swimming pools.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of making a rigid fiber mesh grid, comprising the steps of:
forming a plurality of substantially rigidified elongated rods formed from fiber strands;
forming a plurality of substantially round cross section wrapped fiber tows;
tensioning the plurality of wrapped fiber tows in parallel to one another at predetermined laterally spaced intervals;
wetting the wrapped fiber tows with an adhesive;
placing said plurality of substantially rigidified elongated rods on top of and generally perpendicular to the plurality of wetted wrapped fiber tows at spaced intervals; and
curing the adhesive to secure the elongated rods to the plurality of wrapped fiber tows.

2. The method of making a rigid fiber mesh grid according to claim 1, wherein the step of curing the adhesive is performed in a heated furnace.

3. The method of making a rigid fiber mesh grid according to claim 1, wherein the step of curing the adhesive is performed using an infrared light.

4. The method of making a rigid fiber mesh grid according to claim 1, wherein the step of placing said plurality of substantially rigidified elongated rods on top of and generally perpendicular to the plurality of wetted wrapped fiber tows at spaced intervals includes supporting the plurality of substantially rigidified elongated rods on a rotary wheel that individually place the elongated rods at spaced intervals on the wetted wrapped fiber tows.

5. The method of making a rigid fiber mesh grid according to claim 1, further comprising coating the substantially rigidified elongated rods with granular particles.

6. The method of making a rigid fiber mesh grid according to claim 5, further comprising coating the plurality of wetted wrapped fiber tows with granular particles.

7. The method of making a rigid fiber mesh grid according to claim 1, further comprising forming an additional plurality of wrapped fiber tows in parallel to one another at predetermined laterally spaced intervals, wetting the additional plurality of wrapped fiber tows with an adhesive, and applying said additional plurality of wrapped fiber tows over top of said plurality of substantially rigidified elongated rods while supported by the plurality of coated wrapped fiber tows.

8. The method of making a rigid fiber mesh grid according to claim 1, wherein the rigidified elongated rods are formed from carbon fiber strands and the plurality of substantially round cross section wrapped fiber tows include wrapped carbon fiber tows.

9. A method of making a rigid fiber mesh grid, comprising the steps of:
forming a plurality of substantially rigidified elongated rods formed from fiber strands;
forming a first plurality of substantially round cross section wrapped fiber tows;
tensioning the plurality of wrapped fiber tows in parallel to one another at predetermined laterally spaced intervals;
wetting the wrapped fiber tows with an adhesive;
placing said plurality of substantially rigidified elongated rods on top of and generally perpendicular to the plurality of coated wrapped fiber tows at spaced intervals;
forming a second plurality of substantially round cross section wrapped fiber tows in parallel to one another at predetermined laterally spaced intervals, wetting the second plurality of wrapped fiber tows with an adhesive, and applying said second plurality of wrapped fiber tows over top of said plurality of substantially rigidified elongated rods while supported by the first plurality of wetted wrapped fiber tows; and
curing the adhesive to secure the elongated rods to the first and second pluralities of wrapped fiber tows.

10. The method of making a rigid fiber mesh grid according to claim 9, wherein the step of curing the adhesive is performed in a heated furnace.

11. The method of making a rigid fiber mesh grid according to claim 9, wherein the step of curing the adhesive is performed using an infrared light.

12. The method of making a rigid fiber mesh grid according to claim 9, wherein the step of placing said plurality of substantially rigidified elongated rods on top of and generally perpendicular to the first plurality of wetted wrapped fiber tows at spaced intervals includes supporting the plurality of substantially rigidified elongated rods on a rotary wheel that individually place the elongated rods at spaced intervals on the first plurality of wetted wrapped fiber tows.

13. The method of making a rigid fiber mesh grid according to claim 9, further comprising coating the substantially rigidified elongated rods with granular particles.

14. The method of making a rigid fiber mesh grid according to claim 13, further comprising coating the first and second plurality of wetted wrapped fiber tows with granular particles.

15. The method of making a rigid fiber mesh grid according to claim 9, wherein the rigidified elongated rods are formed from carbon fiber strands and the plurality of substantially round cross section wrapped fiber tows include wrapped carbon fiber tows.
